(19) United States
(12) Patent Application Publication
(10) Pub. No.: US 2017/0200154 A1
(43) Pub. Date: Jul. 13, 2017

(54) METHOD FOR PROTECTING THE RESALE OF AN OBJECT PROVIDED WITH AN NFC TAG

(71) Applicant: WISEKEY SEMICONDUCTORS, Meyreuil (FR)

(72) Inventors: Mikaël DUBREUCQ, Aix En Provence (FR); Saad JANATI IDRISSI, Aix En Provence (FR)

(73) Assignee: WISEKEY SEMICONDUCTORS, Meyreuil (FR)

(21) Appl. No.: 15/315,309

(22) PCT Filed: May 27, 2015
(86) PCT No.: PCT/FR2015/051398

§ 371 Date: Nov. 30, 2016

(30) Foreign Application Priority Data
Jun. 2, 2014 (FR) 1454962

(51) Int. Cl. G06Q 20/38; G06Q 20/32; G06Q 20/40; G06K 7/10

(52) U.S. Cl. CPC G06Q 20/3829; G06K 7/10297; G06Q 20/3278; G06Q 20/401

(57) ABSTRACT

A method for securing the sale of an item (OB), including steps of storing item identifier (PCA) and owner identifier (UID) by a server (BSRV) and in a secure memory of electronic tag (TG) linked to item, transmitting item identifier, from electronic tag to a terminal (SP1) through contactless or near field link, providing by the server information (PINF) relative to item (OB) in response to a request (VFRQ) designating item, transmitting to server an update request identifying the owner, containing information relative to the new owner of item, storing by the server the information relative to new owner in relation with item identifier, generating by the server a write request (EID) containing an identifier (UID) of new owner, transmitting write request to electronic tag through contactless or near field link, and storing in the electronic tag the identifier of new owner received in write request.

### FIELD

The present invention relates to the sale and the resale of goods having a high retail value, especially luxury goods and works of art. The present invention especially applies to online sales of such goods.

### BACKGROUND

Many Internet sites offer advertisement services enabling users to offer their items for sale. However, when consulting such ads, it is generally not possible to ensure the authenticity of a sold item, nor that the person who published the ad owns or actually even has the item.

Some goods may have an authenticity certificate in printed form. However, such an authenticity certificate is not directly accessible on-site, thus the authenticity of such a certificate is difficult to establish. Potential buyers are thus not encouraged to buy goods whose value is essentially linked to their authenticity.

Some online selling sites offer a service to control the authenticity of sold goods. However, a relatively large fee is requested in exchange, and the confidence attributed to such a service may be limited. Potential sellers are thus not encouraged to use such a service.

Moreover, many stolen goods transit from one country to another. It may be desired to verify that an item is actually in the custody of its owner or a person authorized by the owner. Only goods of greater value are tracked in lists and may be subject to verification. However, ensuring that a particular item is not listed as stolen implies having access to the stolen goods lists. Such access is not always possible though, and it may be difficult to link an item to its description in a stolen goods list.

In addition, it is known to associate an item with an electronic tag such as an RFID (RadioFrequency IDentification) or NFC (Near Field Communication) tag, identifying the item and possibly storing other information about the item such as its origin, its manufacturing date.

It may thus be desired to allow a potential buyer to confirm the authenticity of an item offered for sale, and to confirm that the seller truly is the owner of the item. It may also be desirable to offer the owner of an item the possibility to transfer to another person the ability to remotely confirm the authenticity of the item. It may also be desirable to immediately control, without having to connect to a remote server, that an item is actually in the custody of its owner or a person approved by the owner.

### SUMMARY

Embodiments relate to a method for securing the sale of an item, comprising the steps of storing an item identifier and an owner identifier by a server and in a secure memory of an electronic tag linked to the item, transmitting the item identifier, from the electronic tag to a terminal through a contactless or near field link, providing by the server information relative to the item in response to a request designating the item, transmitting to the server an update request identifying the owner, containing information relative to the new owner of the item, storing by the server the information relative to the new owner in relation with the item identifier, generating by the server a write request containing an identifier of the new owner, transmitting the write request to the electronic tag through the contactless or near field link, and storing in the electronic tag the identifier of the new owner received in the write request.

According to an embodiment, the method comprises steps of providing by the server an access code in response to a request containing the item identifier, and providing the information relative to the item by the server in response to a request containing the access code.

According to an embodiment, the method comprises a step of providing by the server, in response to the request containing the access code, information relative to the owner of the item.

According to an embodiment, the method comprises a step of providing by the electronic tag in response to a read request, information relative to the item and eventually information relative to the owner of the item.

According to an embodiment, the write request generated by the server securely identifies the server as the requester, the identifier of the new owner, received in the write request, being stored securely in the electronic tag only if the transmitter of the request is the server.

According to an embodiment, the method comprises steps of selecting by the server an encryption key based on the received item identifier, generating by the server with the encryption key cryptographic data containing, in encrypted, form the owner identifier received from the terminal, transmitting the cryptographic data to the electronic tag, decrypting the cryptographic data by the electronic tag using a decryption key corresponding to the encryption key, to obtain the owner identifier, and securely storing the owner identifier in the electronic tag.

According to an embodiment, the encryption and decryption keys are identical and correspond to a secret key, the owner identifier being encrypted using a symmetrical cipher, or the encryption key is a public key and the decryption key is a private key corresponding to the public key, the owner identifier being encrypted using an asymmetric cipher, the cryptographic data including an electronic signature issued by the server, the method comprising a step of verifying by the electronic tag that the signature has been issued by the server.

According to an embodiment, the steps of storing by the server of the information relative to the owner and of transmitting by the server of the write request are achieved only if the owner is identified as such by the server.

According to an embodiment, the owner is identified as such by the server through the provision to the server by the owner of a secret code generated by the server and issued to the owner by a seller of the item, or in a period during which the server authorizes updating of the owner identifier in the electronic tag.

Embodiments also relate to a transaction system for the sale of an item, comprising a server accessible through a data transmission network, an electronic tag linked to an item, and a terminal including communication interfaces for establishing a contactless or near field communication with the electronic tag and for establishing a communication with the server, the electronic tag being configured for storing an item identifier in a secure memory of the electronic tag, transmitting the item identifier, receiving a write request containing an identifier of the owner of the item, storing in the secure memory the owner identifier received in the write request, the server being configured for receiving and storing information relative to the owner of the item, in relation with information relative to the item, providing information relative to the item in response to a request designating the item, generating and transmitting the write request containing an owner identifier, the terminal being configured for reading the information relative to the item and to the owner of the item stored in the electronic tag, transmitting to the server an update request of the owner identification information in the electronic tag, and transmitting to the electronic tag the write request issued by the server.

According to an embodiment, the server is configured for providing an access code in response to a request containing the object identifier, and providing in response to a request containing the access code, the information relative to the item, and eventually the information relative to the owner of the item.

According to an embodiment, the electronic tag is configured for providing in response to a read request, information stored by the electronic tag relative to the item, and eventually relative to the owner of the item.

According to an embodiment, the server is configured for storing information relative to the owner and issuing the owner identifier to the electronic tag only if the owner is identified as such by server.

According to an embodiment, the server is configured for generating a secret code to the seller of the item and for identifying as the owner of the item a person providing the secret code.

According to an embodiment, the server is configured for identifying as the owner of the item a person providing identification information in a period during which the server authorizes updating of the owner identifier in the electronic tag.

### BRIEF DESCRIPTION OF DRAWINGS

Other advantages and features will become more clearly apparent from the following description of particular embodiments of the invention provided for exemplary purposes only and represented in the appended drawings, in which:

FIG. 1 schematically shows steps of a procedure for recording information relative to the owner of an item having an electronic tag, according to an embodiment;

FIG. 2 schematically shows and electronic tag and a terminal having an interface for communicating with the electronic tag;

FIG. 3 schematically shows steps of a procedure for offering for sale an item having an electronic tag, according to an embodiment;

FIG. 4 shows steps of a procedure for recording information relative to the owner of an item having an electronic tag, according to an embodiment;

FIG. 5 schematically shows steps of a procedure for offering for sale an item having an electronic tag, according to another embodiment;

FIG. 6 shows steps of a procedure for recording information relative to the owner of an item having an electronic tag, according to another embodiment;

FIGS. 7 schematically shows steps of a procedure for offering for sale an item having an electronic tag, according to another embodiment.

### DESCRIPTION OF EMBODIMENTS

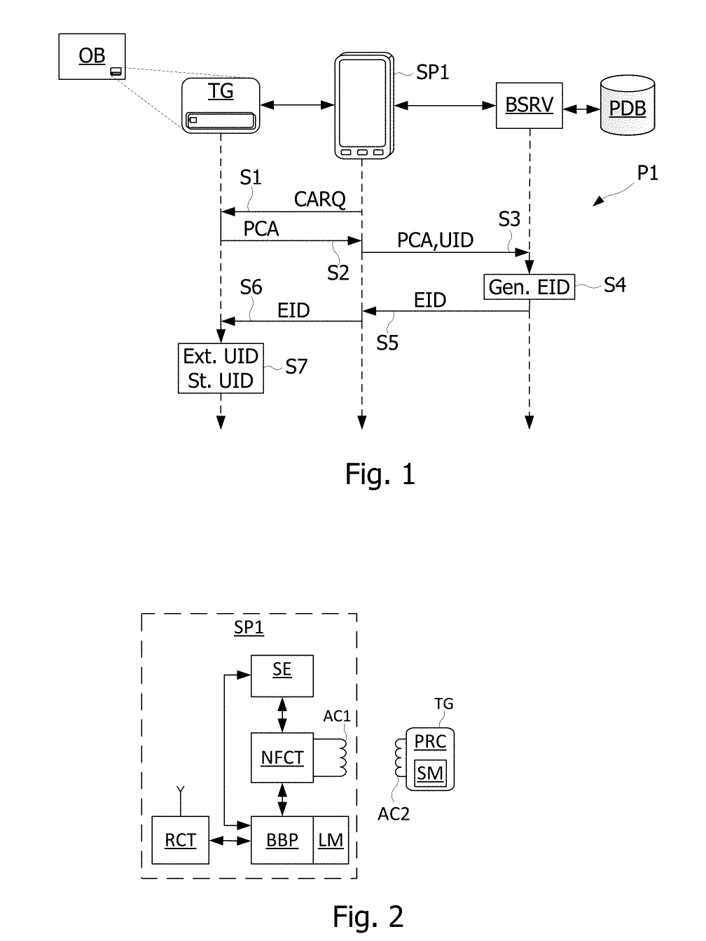

FIG. 1 shows steps S1 to S7 of a procedure P1 carried out according to an embodiment, following the purchase of an item OB associated with an electronic identification tag TG, including a contactless RFID or near field NFC chip. The procedure P1 may be carried out from a communication terminal SP1 configured to communicate with the electronic tag TG (RFID or NFC tag) and with a remote server BSRV linked to the manufacturer of the item OB.

FIG. 2 shows an example of a terminal SP1 and of an electronic tag TG. The terminal SP1 includes a processor BBP and a memory LM, for executing applications, a contactless or near field communications interface NFCT, NFC connected to an antenna circuit AC1 and a communications interface RCT for exchanging information through networks, such as mobile phone networks, wireless networks, and the Internet. The processor BBP is connected to the memory LM and to the circuits NFCT and RCT. The terminal SP1 may also include a secure circuit SE such as a SIM card (Subscriber Identity Module) connected to the processor BBP. The terminal SP1 may for instance be a so-called intelligent mobile phone (smartphone). The tag TG includes a processor PRC, a secure memory SM and an antenna circuit AC2.

The terminal SP1 may communicate with the server BSRV, for instance through the Internet and for example using a dedicated application, installed in the terminal SP1. According to an alternative, the terminal SP1 may be an NFC reader connected to the server BSRV. Following or during manufacturing of the item OB, or following an authentication of the item OB, the tag TG is bonded to the item OB such that the tag TG is difficult to remove from the item without damaging the item. An identifier PCA of the tag TG and/or of the item OB is recorded in a database PDB accessible to the server BSRV, together with information relative to the item OB, such as a description of the item, its date and location of manufacturing, a picture of the item, etc. A certificate of authenticity of the item OB may also be stored in a secure memory of the tag TG and may also be stored in the database PDB.

At step S1, the terminal SP1 establishes a communication with the tag TG and transmits thereto an identifier request CARQ for obtaining an identifier PCA of the item OB. The identifier PCA may be the certificate of authenticity of the item or a certificate excerpt. At step S2, the tag TG transmits the requested identifier PCA. At step S3, the terminal SP1 establishes a communication with the server BSRV. To this end, the dedicated application installed in the terminal SP1 may have a URL address for accessing the server BSRV. The terminal SP1 then transmits to the server BSRV the identifier PCA, and identification information UID linked to the owner of the item OB, that may have been previously stored in the terminal SP1. The identification information may include the last name, first name, the address and telephone number of the owner.

At step S4, the server BSRV receives this information and generates cryptographic data EID based on the identifier PCA and the identification information UID, and transmits the data EID to the terminal SP1. The cryptographic data EID is generated for example by encrypting the identification information UID of the owner of the item OB and possibly the identifier PCA with a symmetric cipher and a secret key known only by the server BSRV and the tag TG. The cryptographic data EID may also be generated for example by encrypting the identification information UID and possibly the identifier PCA, with a public key of the tag TG and an asymmetric key cipher. The cryptographic data EID may also include an electronic signature generated for example with a private key known only by the server BSRV, the corresponding public key being stored in the tag TG. At step S4, the server BSRV may also store in the database PDB the identification information UID of the owner of the item together with the identifier PCA of the item OB. At step S5, the server BSRV transmits the cryptographic data EID to the terminal SP1. At step S6, the terminal SP1 receives the cryptographic data EID and transmits it to the tag TG. At step S7, the tag TG receives the cryptographic data EID, and decrypts the cryptographic data EID with the secret key or a private key corresponding to the public key used by the server BSRV. The tag TG also checks, if necessary, the electronic signature with the public key of the server BSRV read from its memory. If the data EID can be decrypted, and eventually if the signature is authentic, the tag TG stores the identification information UID resulting from the decryption in its secure memory. Information identifying the owner of the item OB is thus stored securely in the tag TG.

Note that the generation of the cryptographic data serves the purpose of authorizing the storing of information in the secure memory of the tag TG only if the information originates from an authorized entity, i.e. the server BSRV. This measure for storing the identifier UID of the owner in the tag TG may not be necessary assuming that the conformity between the owner data stored in the tag TG and the data stored by the server BSRV in the database PDB can be verified. Indeed, the database PDB also stores the information relating to the owner of the item.

Note also that when using a symmetrical cipher, the decrypted data may be systematically stored in the secure memory, assuming that, if the used encryption key is incorrect, the result of the decryption will not provide the identification information UID.

The steps S4 to S7 may also be carried out upon a first sale of the item OB, for example in a retail shop where the item is purchased, or before shipping the item for an online sale, or by the purchaser himself using his mobile phone in which the dedicated application is installed.

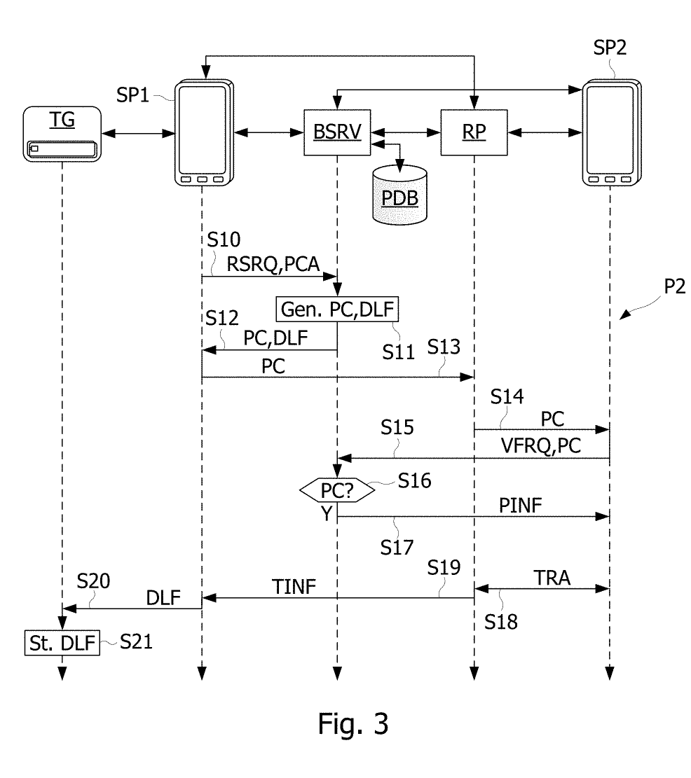

FIG. 3 shows steps S10 to S21 of a procedure P2 carried out upon resale of the item OB. At step S10, the terminal SP1 transmits to the server BSRV, upon request by the user of the terminal, an identification request RSRQ for reselling the item. The request RSRQ contains the identifier PCA of the item OB, which can be extracted from the authenticity certificate of the item OB, stored in the tag TG or the certificate. The identifier PCA may be obtained by executing steps S1 and S2. At a step S11, the server BSRV receives the request RSRQ and generates a code PC for accessing information linked to the item, and possibly cryptographic data DLF allowing deletion of the identification information UID of the owner of the item OB in the secure memory of the tag TG. The cryptographic data DLF may be configured such that it contains no information related to the owner of the item OB and that it can be stored in the secure memory of the tag TG replacing the identification information UID. To this end, the cryptographic data DLF may be generated in the same way as the data EID, but without containing identification information UID. At step S12, the server BSRV responds to the request RSRQ by transmitting to the terminal SP1 the code PC for accessing the information relating to the item OB, and the cryptographic data DLF. Note that the access code PC may be a URL address (Uniform Resource Locator) providing access to the information relating to the item OB, stored in the database PDB. The steps S10 to S12 may be preceded by a step for connecting the terminal SP1 to the server BSRV requiring a valid login operation. In this manner, only the owner of the item, previously registered in the server BSRV, may obtain the access code PC, and thus initiate a sale of the item OB.

At step S13, the owner of the item OB decides to resell the item OB, for example by publishing an ad on an Internet site hosted on a server RP. The access code PC may appear on the sales ad so that any person knowing this code may interrogate the server BSRV for obtaining information relative to the item OB. The access code PC may also appear in the ad in the form of a hypertext link for accessing the server BSRV and obtaining the information relative to the object OB stored in the database PDB. At step S14, a person consults the ad on the server RP with a terminal SP2, and obtains the access code PC. The terminal SP2 may for instance be a smartphone or a personal computer connected to the Internet. At step S15, the terminal SP2 accesses server BSRV for transmitting an authenticity verification request VFRQ containing the access code PC. At step S16, the server BSRV tests the access code PC and executes step S17 only if the code is valid. At step S17, the server BSRV responds to the terminal SP2 by providing the information PINF relative to the item, stored in the database PDB, and corresponding to the access code PC. Based on this information, the user of terminal SP2 can appreciate the authenticity of the item OB and whether the information mentioned in the ad conforms to the information PINF obtained at step S17. At step S18, the user of the terminal SP2 decides to purchase the item OB and conducts a purchase transaction TRA with the server RP or directly with the owner of item OB. At step S19, the owner of the item OB is informed that the conclusion of the transaction is valid. To this purpose, the terminal SP1 may receive information TINF relative to the purchase transaction. At step S20, the terminal SP1 proceeds, at the request of the owner of item OB, to the deletion of the identification information UID in the memory of tag TG. To this purpose, the terminal SP1 transmits to the tag TG the cryptographic data DLF that was stored by the terminal SP1 at step S12. At step S21 the tag TG receives the data DLF and processes it in the same way as the cryptographic data EID, resulting in the deletion of the information UID in the secure memory of the tag TG. The owner may then transfer the item OB to the purchaser. The purchaser may then store his personal identification information in the tag TG of the item OB by installing the dedicated application in his terminal SP2 and by initiating it for executing the steps S1 to S7. At step S4, the server BSRV may store the identification information UID of the purchaser, in association with the identifier PCA of the item OB. The identifier UID may be read upon request like the identifier PCA at steps S1, S2. The authenticity of the item OB, together with the identity of the owner of the item OB may thus be verified directly, without accessing the database PDB through server BSRV.

It should be noted that the steps S20, S21 may be omitted if the step S7 results in the overwriting of the eventual identification data UID of the owner, previously stored in the secure memory of the tag TG.

Of course, the purchase transaction may be achieved without using a server, such as the server RP, directly between the owner of the item and the purchaser. In this case, the execution of steps S13 and S14 to S19 may be omitted. The purchaser may however verify the authenticity of the item OB by directly reading the tag TG, and eventually by transmitting the identifier PCA of the item thus obtained to the server BSRV with the dedicated application.

Thanks to this procedure, the seller of the item OB may obtain recognition of the authenticity of the item OB and therefore of the value of the item. The purchaser of the item OB may be assured of the authenticity of the item before deciding to purchase the item. The purchaser of the item OB may also be referenced in the server BSRV and may thus benefit from eventual services reserved to the owners of items referenced in the database PDB. Thanks to a simple server BSRV and a dedicated application, adapted to phones having an NFC interface, item manufacturers may offer their clients the possibility to readily sell their items at an equitable price. The item manufacturer may also follow the item ownership changes, and thus offer the seller to purchase new items, and include the purchaser in a client list. The owner of the item OB may notify the server BSRV that the item was stolen, and the server BSRV may detect the reappearance of a stolen item through the requests received at steps S3, S10 and S15. The sales advertising server RP stays completely independent of the manufacturer of item OB, and requires no adaptation in its advertisement services, while benefiting from the possibility of offering ads for selling items having a value linked to the authenticity of the items.

Moreover, the tag TG enables both the verification of the authenticity of the item OB and that the item is in the hands of the owner or of an authorized person, without accessing the server BSRV. This possibility is offered to any person, especially a control organization (customs, police), equipped with a phone or reader having a contactless or near-field interface. To this end, the tag TG may store other information relative to the owner of the item OB, such as information for establishing the identity of the owner (name, address, biometric data, etc.). Additional information may also be obtained from the server BSRV based on the identifier PCA of the tag TG.

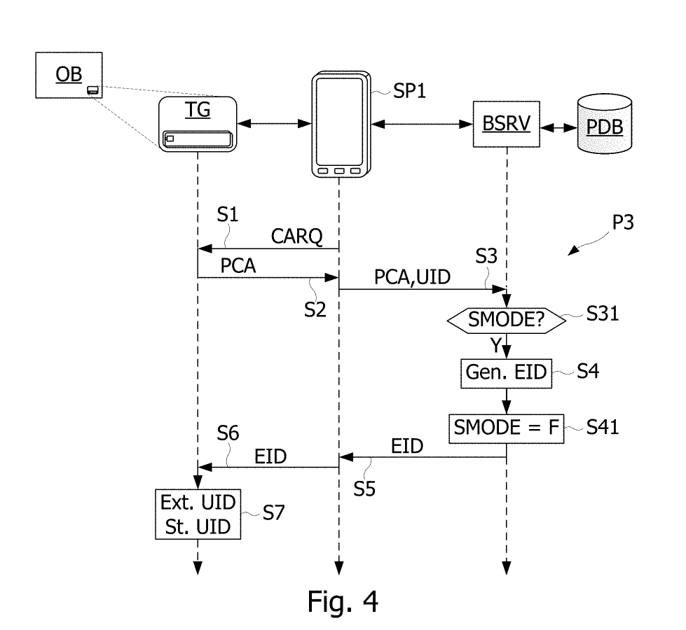

FIG. 4 illustrates steps of a procedure P3 executed according to another embodiment following the purchase of an item OB associated to the electronic identification tag TG, having an NFC or RFID chip. The procedure P3 differs from procedure P1 in that it includes additional steps S31, S41. The step S31 is executed by the server BSRV between the steps S3 and S4. The step S31 includes checking that the tag TG is in an update status in the database PDB, the server BSRV having been informed by the owner of the item of the results of a sale of the item. The subsequent steps S4, S41 and S5 to S7 are only executed if the server BSRV is informed that the item is on sale. The step S41 is executed by the server BSRV between the steps S4 and S5. At step S41, the server BSRV can update the database PDB in order to cancel the update status of the tag TG. In this way, the tag TG may receive a new owner identifier at step S7 only if the owner of the item has informed the server BSRV that the item is on sale. Moreover, the updating of the tag TG at step S7 can only be achieved once, as long as the owner of the item has not informed the server BSRV of a new sale of the item OB.

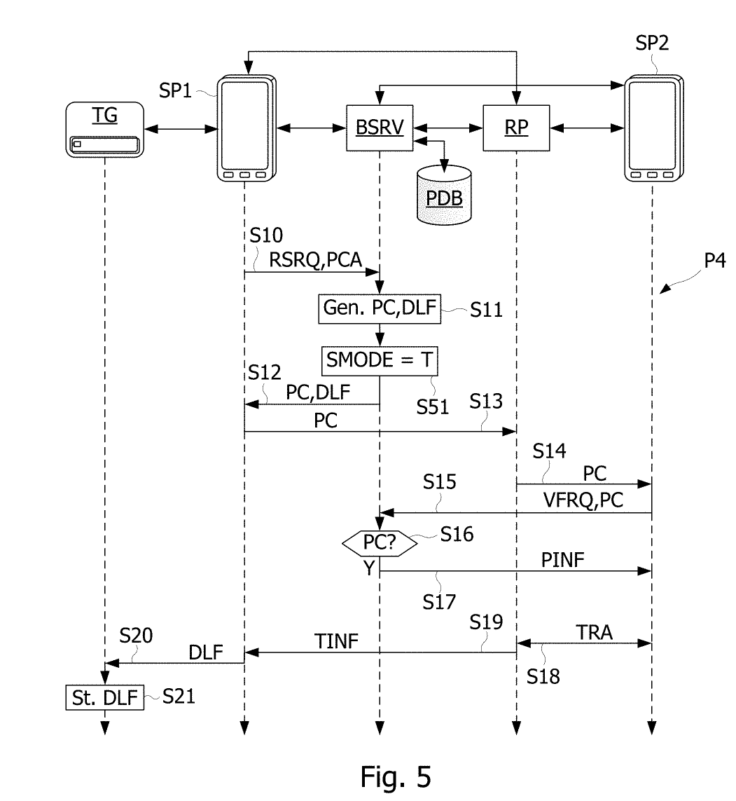

FIG. 5 illustrates steps of a procedure P4 executed upon offering the item OB for sale and resale, according to another embodiment. The procedure P4 differs from the procedure P2 in that it includes an additional step S51 executed between the steps S11 and S12. The step S51 includes storing by the server BSRV in the database PDB the event that the tag TG is in an update mode, following the offer for sale of the item OB such as declared by the transmission of the request RSRQ at step S10. The activation of this mode is tested at step S31. The item OB can thus be associated in the database PDB to a status having one of the following values: owner not attributed, owner attributed, on sale, stolen.

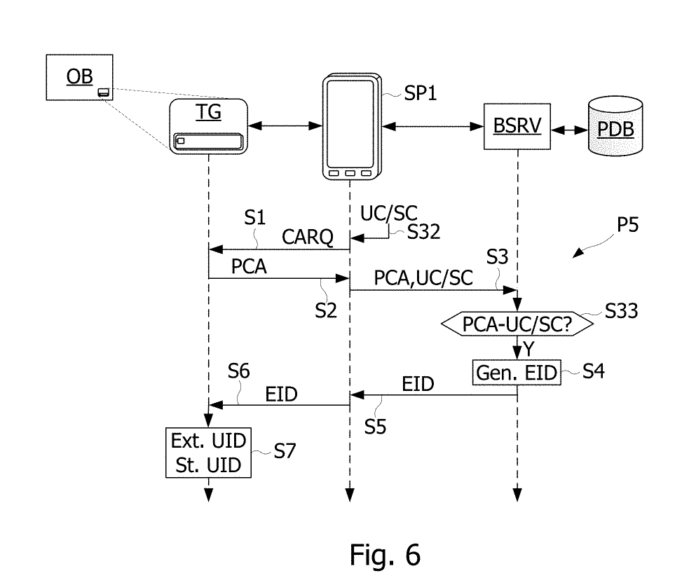

FIG. 6 illustrates the steps of a procedure P5 executed according to another embodiment, following the purchase of the item OB associated to the electronic identification tag TG, having an NFC or RFID chip. The procedure P5 differs from the procedure P1 in that it includes additional steps S32 and S33 and in that the step S3 is modified. The step S32 is executed before the step S1 or S3 to condition the execution of the step S7 to a prior identification of the owner of the item OB. At step S32, the owner introduces on his terminal SP1 executing the dedicated application an identifier/password pair UC or a secret code SC. The secret code SC may have been transmitted by the seller of the item OB when the item was purchased by the owner of the item OB. The step S33 is executed between the steps S3 and S4. At step S3, the terminal SP1 also transmits to the server BSRV the data UC or SC. At step S33, the server BSRV verifies the identifier PCA, the identifier/password pair UC, and that the item corresponding to the identifier PCA is associated in the database PDB to the identifier/password pair UC or to the secret code SC. The execution of steps S4 to S7 is only achieved if the owner identified by the data UC or SC corresponds to the identifier of the item OB. Thus, updating of the identifier UID of the owner of the item OB in the tag TG and in the database PDB is only possible if the owner has been identified as such in the server BSRV. As a consequence, such updating is not possible unbeknownst to the owner of the item, especially if the item has been stolen.

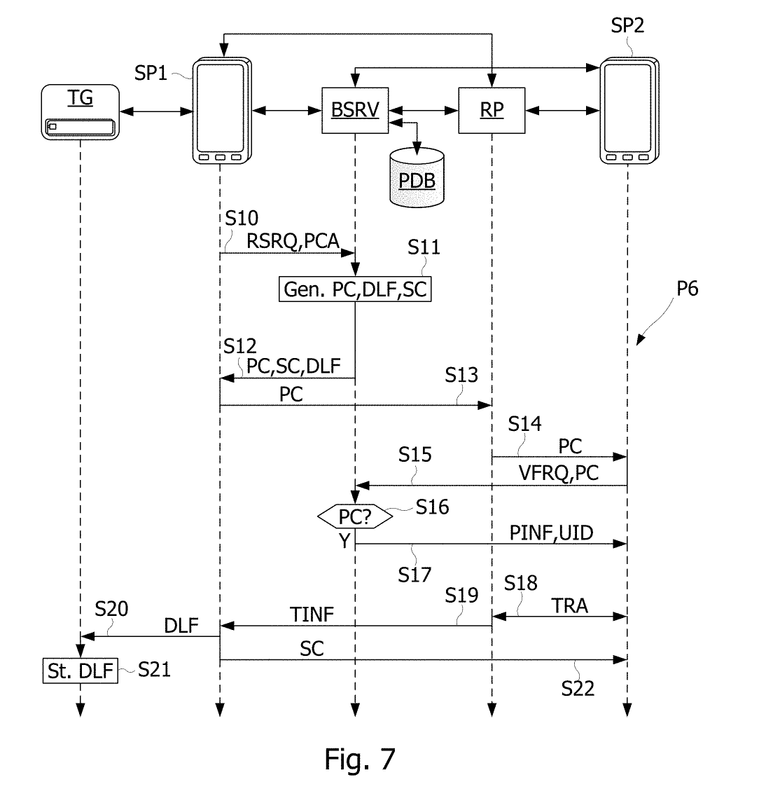

FIG. 7 illustrates steps of a procedure P6 executed upon offering the item OB for sale and resale, according to another embodiment. The procedure P6 differs from the procedure P2 in that the steps S11, S12 and S17 are modified. At step S11, the server BSRV generates the secret code SC used in the procedure P5 and updates the database PDB for storing this secret code in association with the data relative to the item OB. At step S12, the secret code SC is also transmitted to the terminal SP1 and displayed thereon to inform the owner of the item OB. At step S17, the server BSRV transmits to the terminal SP2 of the potential purchaser identification information UID of the owner of the item together with the information PINF relative to the item OB. This information is displayed on the terminal SP2. The potential purchaser may thus verify that the received identification information UID corresponds to the person at the origin of the publication of the ad for selling the item OB on the server RP and is indeed the owner of the item OB. This procedure avoids unauthorized use of the access code PC by another person, and hence that the sales transaction is conducted at step S18 with a person other than the owner of the item.

The procedure P6 may include an additional step S22 executed after the step S19, when the owner of the item OB is informed of the transaction. At step S22, the terminal SP1 transmits to the terminal SP2 the secret code SC authorizing updating of the tag TG with the identification information of the purchaser of the item OB. The purchaser of the item OB may thus be stored as the owner of the item OB in the tag TG and in the database PDB, by executing the procedure P5 on his terminal SP2 after installing the dedicated application. The secret code SC may be transmitted between the two terminals SP1, SP2 for instance by an SMS (Short Message Service) after introducing in the terminal SP1 the telephone number of terminal SP2, or by email after introducing in the terminal SP1 an email address of the purchaser.

Like before, the acquisition transaction may be achieved without going through a server such as the server RP, but directly between the owner of the item and the purchaser. The purchaser may verify the authenticity of the item OB and that the seller is indeed the owner of the item by directly reading the tag TG. Additional information may then be obtained by accessing the server BSRV and by using the identifier PCA of the item OB.

It will appear to those skilled in the art that the present invention may be subject to various alternatives and applications. In particular, the invention is not limited to the disclosed embodiments, and covers any combination of these embodiments. Moreover, it is not necessary that the server BSRV generates the code PC to access the information stored by the server relative to the item. Indeed, this code may be replaced by the identifier PCA read in the tag TG, and which is also stored in the database PDB by the server. The owner of the item may thus offer the item for sale without informing the server BSRV. For ensuring security while updating the tag TG with the new owner identifier, it is sufficient that the owner of the item informs the server of the sale of the item (by executing the steps S10 to S12). As a result, the update mode of the tag may be enabled (S51) and/or the secret code SC may be generated (S11—procedure P6) only when the server is informed of the sale of the item.

1-15. (canceled)

16. A method for securing the sale of an item, comprising the following steps:
storing an item identifier and an owner identifier by a server and in a secure memory of an electronic tag linked to the item,
transmitting the item identifier, from the electronic tag to a terminal through a contactless or near field link,
providing by the server information relative to the item in response to a request designating the item,
transmitting to the server an update request identifying the owner, containing information relative to the new owner of the item,
storing by the server the information relative to the new owner in relation with the item identifier,
generating by the server a write request containing an identifier of the new owner,
transmitting the write request to the electronic tag through the contactless or near field link, and
storing in the electronic tag the identifier of the new owner received in the write request.

17. The method according to claim 16, comprising the steps of:
providing by the server an access code in response to a request containing the item identifier, and
providing the information relative to the item by the server in response to a request containing the access code.

18. The method according to claim 17, comprising the step of providing by the server, in response to the request containing the access code, information relative to the owner of the item.

19. The method of claim 16, comprising the step of providing by the electronic tag in response to a read request, information relative to the item and eventually information relative to the owner of the item.

20. The method of claim 16, wherein the write request generated by the server securely identifies the server as the requester, the identifier of the new owner, received in the write request, being stored securely in the electronic tag only if the transmitter of the request is the server.

21. The method of claim 16, comprising the steps of:
selecting by the server an encryption key based on the received item identifier,
generating by the server with the encryption key cryptographic data containing, in encrypted, form the owner identifier received from the terminal,
transmitting the cryptographic data to the electronic tag,
decrypting the cryptographic data by the electronic tag using a decryption key corresponding to the encryption key, to obtain the owner identifier, and
securely storing the owner identifier in the electronic tag.

22. The method of claim 21, wherein:
the encryption and decryption keys are identical and correspond to a secret key, the owner identifier being encrypted using a symmetrical cipher, or
the encryption key is a public key and the decryption key is a private key corresponding to the public key, the owner identifier being encrypted using an asymmetric cipher, the cryptographic data including an electronic signature issued by the server, the method comprising a step of verifying by the electronic tag that the signature has been issued by the server.

23. The method of claim 16, wherein the steps of storing by the server of the information relative to the owner and of transmitting by the server of the write request are achieved only if the owner is identified as such by the server.

24. The method of claim 23, wherein the owner is identified as such by the server through the provision to the server by the owner of a secret code generated by the server and issued to the owner by a seller of the item, or in a period during which the server authorizes updating of the owner identifier in the electronic tag.

25. A transaction system for the sale of an item, comprising:
a server accessible through a data transmission network,
an electronic tag linked to an item, and
a terminal including communication interfaces for establishing a contactless or near field communication with the electronic tag and for establishing a communication with the server,
the electronic tag being configured for:
storing an item identifier in a secure memory of the electronic tag,
transmitting the item identifier,
receiving a write request containing an identifier of the owner of the item,
storing in the secure memory the owner identifier received in the write request,
the server being configured for:
receiving and storing information relative to the owner of the item, in relation with information relative to the item,
providing information relative to the item in response to a request designating the item,
generating and transmitting the write request containing an owner identifier,
the terminal being configured for:
reading the information relative to the item and to the owner of the item stored in the electronic tag,
transmitting to the server an update request of the owner identification information in the electronic tag, and
transmitting to the electronic tag the write request issued by the server.

26. The system of claim 25, wherein the server is configured for:
providing an access code in response to a request containing the object identifier, and
providing in response to a request containing the access code, the information relative to the item, and eventually the information relative to the owner of the item.

27. The system of claim 25, wherein the electronic tag is configured for providing in response to a read request, information stored by the electronic tag relative to the item, and eventually relative to the owner of the item.

28. The system of claim 25, wherein the server is configured for storing information relative to the owner and issuing the owner identifier to the electronic tag only if the owner is identified as such by server.

29. The system of claim 25, wherein the server is configured for generating a secret code to the seller of the item and for identifying as the owner of the item a person providing the secret code.

30. The system of claim 25, wherein the server is configured for identifying as the owner of the item a person providing identification information in a period during which the server authorizes updating of the owner identifier in the electronic tag.
